(19) United States
(12) Patent Application Publication
(10) Pub. No.: US 2020/0100087 A1
(43) Pub. Date: Mar. 26, 2020

(54) CONTROLLING AT LEAST ONE CONTROLLABLE DEVICE ARRANGED IN A REGION PREDEFINED BY A LIGHTING DEVICE

(71) Applicant: OSRAM GMBH, München (DE)

(72) Inventors: Christoph PEITZ, Lippstadt (DE); Henry FEIL, Unterhaching (DE); Andreas ZAGGL, München (DE); Karl-Heinz WALLWITZ, München (DE)

(21) Appl. No.: 16/472,046

(22) PCT Filed: Dec. 22, 2017
(86) PCT No.: PCT/EP2017/084367

§ 371 Date: Jun. 20, 2019

(30) Foreign Application Priority Data
Dec. 23, 2016 (DE) 10 2016 125 661.7

(51) Int. Cl. H04W 8/00; G08C 17/02; H05B 37/02

(52) U.S. Cl. CPC H04W 8/005; H05B 37/0272; G08C 17/02

(57) ABSTRACT

The invention relates to a method for controlling at least one controllable device, arranged in a predefined region, by means of a communications terminal, wherein a transmitting device sends out a radio signal wirelessly, the radio signal having identification data specific to the transmitting device, having the steps: assigning the at least one controllable device to the transmitting device, receiving the radio signal by means of the communications terminal, evaluating the radio signal in order to capture the specific identification data, identifying the at least one controllable device assigned to the transmitting device using the captured specific identification data, establishing a communication link between the at least one device and the communications terminal and transmitting data corresponding to a control command in order to control the at least one device.

The invention relates to a method for controlling at least one controllable device arranged in a preset region by means of a communications terminal, wherein a transmitting device wirelessly emits a radio signal with identification data specific to the transmitting device. Moreover, the invention relates to a system for controlling at least one controllable device arranged in a preset region.

Fundamentally, methods and systems of the generic type as well as also lighting devices and transmitting devices of the generic type are extensively known in the prior art such that a separate printed evidence is not required hereto. Rooms, for example outside of or also within buildings, are illuminated by lighting devices in presettable manner to allow or support intended use. Lighting devices are increasingly employed for the lighting devices, which besides an illuminant, which emits light in presettable manner, also comprise a transmitting device, which is at least formed to wirelessly emit the specific identification data, for example in the manner of broadcast. Preferably, this transmitting device is formed to emit the radio signal in the manner of near-field radio. For emitting the radio signal, a radio standard, such as for example Bluetooth, WiFi, ZigBee or the like, can be used. Such a transmitting device is also referred to as “beacon” in the prior art.

So-called beacons can be combined with lighting devices to provide lamp-specific or also other information by means of their signal. The beacon technology is based on a transmitter system or also a transceiver system. A beacon (in German also Leuchtfeuer, Bake or Peilsender) is a small, mostly battery-operated transmitter, which emits a signal in, preferably definable, time intervals, for example based on a Bluetooth Low Energy (BLE) standard. The signal of a beacon is characterized by the specific identification data, which for example includes a unique identification number, for example termed universally unic identifier (UUID) in English. Beacons can be used to assign an, in particular digital, identification to objects and/or locations. Objects, at which a beacon is installed, as well as also locations, at which a beacon is installed, for example on a wall or a ceiling, can be identified by communications terminals, for example smartphones, laptops and/or the like, in the signal field of the beacon in this manner.

Thereby, a location can for example be identified and localization can be performed, respectively, with the aid of a beacon. By arranging one or more beacons in a preset region, for example a building region or the like, a type of radio-based raster can be provided, which allows a communications terminal located in the region ascertaining the own position by means of its radio interface, in particular BLE interface, as well as corresponding evaluation possibilities. Therein, the specific identification data of the installed beacons give an identifier to a location, based on which the communications terminal can, at least approximately, determine the position. Anyway, a transmission area of a respective beacon can basically be ascertained. By suitable evaluation, for example using preset algorithms or the like, the accuracy of the ascertained position can be improved, for example by evaluating a signal strength and/or the like. Hereto, the communications terminal can preferably access data of a data storage, for example via a communication network like the Internet and/or the like. The data storage can for example be a Cloud server or the like. Here, the identification data and an associated position can for example be noted in a map. However, the data storage can also at least partially be present on the communications terminal.

If the communications terminal comes into the range of the transmitting device or the beacon, it can thus ascertain the own site for example via server query based on the ascertained specific identification data. Using further signals of further transmitting devices or beacons, the accuracy can be improved by means of localization algorithms, in particular a distance can be ascertained from a receiving field strength of the respective signal of the transmitting device or the beacon.

Basically, transmitting devices or beacons can be installed at lighting devices of the generic type in the light technology. Therein, the advantage can in particular be utilized that a light installation can provide a permanent energy access to supply the transmitting device or the beacon with electrical energy. An advantage results from it, namely that the transmitting device or the beacon does not require an own energy supply in the form of a battery and thus corresponding maintenance expenditure can be saved. Moreover, this configuration allows that settings of the transmitting device or the beacon can also be chosen, which entail high energy consumption without having effects on a lifetime of the beacon. Moreover, installation processes of such transmitting devices or beacons and the light technology can be unified.

A further advantage is a defined locking position of the transmitting device or the beacon, which is preferably selected such that the transmitting device or the beacon is protected from manipulation. Thereby, a reliable secure identifier can thus be assigned to a location.

An overview over use potentials of the integration of a transmitting device or a beacon in a lighting device can be taken from the following enumeration:
The energy supply of the light installation can be used instead of an energy supply by a battery to for example reduce lifecycle cost of the transmitting device or the beacon.
The electrical energy supply of the lighting device can be used to adapt transmission parameters of the signal of the transmitting device or the beacon to the service and not to an available residual amount of energy or parameters of the battery. Frequent transmission cycles for example generate a high accuracy of a respective service, but this also results in increased energy consumption.
The exchange of the battery of conventional transmitting devices or beacons bears risks, namely for example with regard to errors in the handling.
A non-availability of services can be avoided by an uninterrupted energy supply of the transmitting device or the beacon.
An installation location below a ceiling can be advantageous for a signal propagation of the signal of the transmitting device or the beacon.
An installation location below the ceiling can make the overall system more robust against disturbances and shadings, respectively, by other objects at the level of a floor level in contrast to an installation of the transmitting device or the beacon itself at the level of the floor level.
The transmitting device or the beacon can be protected from manipulations and unauthorized accesses, respectively, whether unintentional or intentional.
A system as well as also services such as for example localization services or the like can be offered as an overall system “from a single source”.
Moreover, there is the possibility of using a secure communication network of the system to for example configure the transmitting device or the beacon or to link the transmitting devices or the beacons with each other.
A unification of installation processes of transmitting devices or beacons and the system can be allowed.
Furthermore, there is the possibility of coupling to further system elements of a peripheral building infrastructure, in particular controllable devices, via the communication network of the system, for example to elements of the safety technology or the like.
An optically attractive system can be provided since the transmitting device or the beacon can be non-visibly arranged in the respective lighting device or in the system.

A beacon can be integrated in a lighting device of a system as a transmitting device. The system can include a plurality of lighting devices. The lighting device includes one or more illuminants besides the beacon, which provide the desired illumination function. The beacon and the lighting device are preferably in communication link with each other. The beacon is preferably arranged integrated in the lighting device. Thus, a separate housing does not have to be provided for the beacon. Thereby, the beacon can be arranged protected at the same time such that the intended function can be provided with high reliability. Further lighting devices of the system are preferably formed identical to the lighting device.

The beacon is formed to wirelessly emit a signal, namely the radio signal, with identification data specific to the beacon. Preferably, the emission is effected by radio using a BLE standard. Further, the beacon preferably includes a control unit, which includes a computer unit as well as a storage unit. An executable computer program is stored in the storage unit, which is provided for the computer unit such that a preset control function can be achieved by means of the computer unit.

Further, the beacon can be connected to further local beacons via a communication link. The communication link is preferably also formed as a wireless communication link, in particular according to the BLE standard. However, it can also at least partially be wired. The communication link between the beacon and the further beacons is for example bidirectional. However, it can also at least partially be unidirectional.

Moreover, the beacon can be connected to a data infrastructure device via a further communication link. The data infrastructure device can serve for controlling the system, here in particular the lighting devices of the system. The infrastructure device can for example be the Internet or else a central service server. The data infrastructure device can further serve for controlling and/or communicating data. The local beacon of the lighting device can be formed as a pure transmitting device in the manner of a broadcasting operation or also as a combined transmitting-receiving device.

The signal of the beacon can be received by means of communications terminals such as for example a smartphone, a LAPTOP and/or the like.

According to an example of use, users and appliances, respectively, can optionally have the challenge to have to orient themselves, to intend to navigate or to locate or use other local digital services within a region, such as for example apps, app functions, Google Maps, Lightify, light control and/or the like. The system with integrated beacons in a preset region can become a localization and orientation system, respectively, for these potentials of use. With a self-localization of the communications terminal realizable thereby, services can now be provided, for example a navigation, provision of location-specific information and/or the like.

An aspect of the beacon technology is the possibility of configuration of typical parameters such as for example a signal strength, a transmission interval and/or the like of the beacon. With different configurations, different scenarios of application can be individually supported. For example, if a high service quality with respect to an accurate localization in short intervals is desired, for example in indoor navigation, very short transmission intervals are for example able to be configured.

In particular in digitally controlled systems, for example using Digital Addressable Lighting Interfaces (DALI), it should be possible to uniquely identify, which illuminant or which lighting device is arranged at which location, to allow an exact control of the lighting devices or the illuminants thereof in a certain region by means of digital light control. Hereto, the lighting devices require a unique address, which reflects their position in a preset region. The expert refers such an assignment of lighting devices to corresponding positions or addresses as to “commissioning”. Herein, multiple information has to be combined, namely the unique identification data of a respective lighting device, an installation location of a respective lighting device in a preset region, that is a physical address of the lighting device, as well as an identifier of the lighting device, that is for example its digital address.

The digital address of a lighting device can usually be communicated to a control or data processing via power line communication or a similar power-based communication link via the energy distribution. The lighting device or a ballast of the lighting device can thus sign up at the control with its digital address. However, the information is thereby not yet available, at which physical location in the preset region the lighting device is actually arranged. However, this information is required if only a defined region is to be lighted, for example only a conference room or a part thereof or the like.

At present, lighting devices or illuminants and at the same time the site thereof usually cannot be readily electronically identified. Typically, it can only be recognized via a label or an impressing, for example on a housing of the lighting device, which type of the lighting device or the illuminant it is. Another expensive possibility is in causing each digitally signed up lighting device within the scope of the system to individually blink and in manually marking position information in a layout.

In order to efficiently connect lighting devices and/or illuminants within the scope of the system to a light management system (LMS), it would be advantageous to have available one or more electronic and digital identification data, respectively, for recognizing the overall system or individual components of the overall system.

Further, a specific problem is in that positions of the lighting devices or illuminants are usually set in an installation plan for a lighting region as for example preset region or service region. This presets to an installer, which of the delivered and commissioned lighting devices, respectively, for example with respect to a lamp type or the like, are to be arranged in which position of the region, for example the building, corresponding to the installation plan.

Location-related employments or services, such as for example navigation of a user or the like, by means of beacons are to be available to the user in a preset region, preferably in permanent manner and without restriction. Besides an uninterrupted electrical energy supply, this also requires regular maintenance and optionally also update of computer programs such as for example the firmware or the like, respectively. In particular, firmware updates of technical systems are of high importance. They usually serve for error elimination, power optimization as well as optionally also for functional expansion of the technical system. Thus, errors, so-called bugs, can for example be fixed, whereby the reliability can be increased. Moreover, security gaps can be closed or technical functions of the system can subsequently be enabled or turned off. Thus, high demand of performing firmware updates in regular, in particular situation-specific intervals, is explained.

The following facts can have to be considered in the application of beacons:
At present, batteries are employed for the energy supply of the beacons. By the requirement of changing these batteries in periodic cycles, high effort as well as correspondingly high lifecycle cost arises for the respective beacon.
High service quality, for example high localization accuracy, high range, short transmission interval and/or the like, usually results in a correspondingly high demand of electrical energy for the transmitting device or the beacon such that the battery in a battery-operated beacon has to be exchanged already after short time, for example after one month, to be able to maintain the intended operation beyond.
Each exchange of a battery additionally bears the risk that the functionality of the localization system can be adversely affected by positional change or false handling of the beacon.
Moreover, there is the problem that an operator does not notice an energy deficiency of the beacon and does not again find the beacon, respectively, if the beacon does not have sufficient residual amount of energy to be able to emit its radio signal.
However, the services of the beacon for example with respect to navigation or the like are preferably to be able to be permanently provided to the users. Hereto, an uninterrupted energy supply is desirable.
Attachment or installation of the beacons at or in or as part of the lighting device would allow with respect to a battery-operated beacon to use the energy supply of the lighting device, for example a ballast of the illuminant or the like, for its own energy supply of the beacon and thus to at least partially substitute the battery of the beacon and to counteract the problems associated therewith.

In a preset region, in which at least one beacon is often also arranged, controllable technical infrastructure elements or devices are often also arranged, for example the lighting device, an air conditioner, shutters and/or the like. These controllable devices can increasingly be controlled by means of communications terminals like smartphones, tablets and/or the like besides conventional operating elements, for example manually operable buttons or switches. Therein, the control is effected depending on the respective controllable device via very different communication interfaces such as for example WLAN, Bluetooth, ZigBee, DALI bus and/or the like.

With increasing number of the devices to be controlled, in particular in a building or a corresponding service area, an unclear overall system can herein be the consequence. In terms of high user friendliness, it is desired to propose the controllable devices located in the near environment for control to the user from its current site. Hereto, the communications terminal requires additional location-related data. Furthermore, it proves desired or even required to protect safety-critical infrastructure devices from unauthorized access.

Thus, the invention is based on the object to improve a method for controlling a controllable device as well as a system hereto.

As the solution, a method as well as a system according to the independent claims is proposed by the invention.

Further advantageous configurations are apparent based on features of the dependent claims.

With respect to a generic method, it is in particular proposed that the method includes the steps of:
assigning the at least one controllable device to the transmitting device,
receiving the radio signal by means of the communications terminal,
evaluating the radio signal for capturing the specific identification data,
ascertaining the at least one controllable device assigned to the transmitting device based on the captured specific identification data,
establishing a communication link between the at least one device and the communications terminal, and
communicating data corresponding to a control command for controlling the at least one device and/or the transmitting device itself.

With respect to a generic system, it is in particular proposed that the system comprises:
the controllable device,
a transmitting device wirelessly emitting a radio signal with identification data specific to the transmitting device, wherein the at least one controllable device is assigned to the transmitting device,
a communications terminal for controlling the controllable device and/or the transmitting device itself, wherein the communications terminal is formed to receive the radio signal and evaluate it for capturing the specific identification data,
an ascertaining unit for ascertaining the at least one controllable device assigned to the transmitting device based on the captured specific identification data,
wherein a communication link between the at least one device and the communications terminal can be established to communicate data corresponding to a control command for controlling the at least one controllable device and/or the transmitting device itself.

The invention is based on the realization that generic methods and systems can be considerably improved by including a local beacon. In that local positioning of the communications terminal can be achieved by the beacon, the user friendliness cannot only be improved, but the safety can also be increased at the same time.

Namely, it is possible by the invention to limit the operability of controllable devices to the preset region. Thereby, it can be avoided that the controllable devices can be controlled in undesired manner from outside of the preset region. In order to herein be able to achieve the required reliability in the intended operation, the transmitting device or the beacon is preferably arranged in or at the lighting device for this reason, which is preferably also located in the preset region. However, the transmitting device or the beacon fundamentally does not have to be arranged in or at the lighting device, but the transmitting device or the beacon can also be arranged distant or separated from the lighting device, for example as a separate component, which can comprise an own housing or the like. Thereby, the transmitting device or the beacon can become part of a light installation, which is arranged in the service area. Preferably, the preset region includes at least a part of the service area. The service area can for example be an office building, but also an open-air area and/or the like.

The preset region is preferably determined by a communication range of the respective communications terminal with the transmitting device or the beacon. The preset region can for example also be determined or preset by the lighting device.

Even if controlling relates to the controllable device, controlling the transmitting device itself is also to be encompassed within the scope of this disclosure. Therefore, controlling can relate both to the device and to the transmitting device or also to both, of course in particular if the transmitting device and the device are for example at least partially formed integrally with each other.

Thus, it can be provided that controlling also includes controlling the transmitting device. Controlling the transmitting device can for example be used to be able to optionally adapt the specific identification data, for example in context of commissioning or the like, but in particular also in particular consideration of the controllable device. Thus, control and/or configuration data specific to transmitting device, for example Universally Unique Identifier (UUID), major ID, minor ID, Uniform Resource Locator (URL), sensor information and/or the like, general further content data, transmission intervals, transmission power, data about the transmission and/or receiving power and/or the like, among other things. Therein, it can be provided that access to the specific identification data can be protected, for example in that access requires authentication.

Moreover, controlling the transmitting device can also serve for immediately controlling the controllable device. For this purpose, the controllable device can be coupled to the transmitting device or the beacon in terms of control. This development can also be advantageously employed if more than one controllable device is assigned to the transmitting device or the beacon. Namely, not only a single controllable device fundamentally has to be assigned to the transmitting device or the beacon, but multiple controllable devices can also be assigned to the transmitting device or the beacon, in particular if they are arranged in the same preset region.

Establishing the communication link between the communications terminal and the controllable device can thus also include that the data is communicated to the transmitting device or the beacon and it performs a corresponding control of the at least one controllable device. Moreover, it can be provided that the transmitting device or the beacon ascertains the corresponding control command from the received data and applies it for controlling the controllable device or forwards it to it.

The transmitting device or the beacon cannot only serve as a pure transmitting device for emitting the radio signal in the manner of broadcast, moreover, they can also comprise a receiving unit, which allows receiving a communication signal, preferably by radio, in particular by near-field radio, for example from the communications terminal, which is in communication range to the transmitting device or the beacon, whereby a transmitting-receiving device is then formed. Thereby, it is possible to provide additional functionality, for example in that the communication signal is evaluated on the transmitting device side or beacon side and further data can be emitted due to the data obtained hereby in addition to the radio signal, for example with respect to a function of the illumination device, fitted illuminants of the lighting device, available data formats and/or the like.

Near-field radio presently in particular means that a communication range in a range of few meters, for example in a range of about 0.5 m to about 25 m, preferably in a range of about 1 m to about 10 m, particularly preferably in a range of about 1.5 m to about 5 m, can be achieved by means of a radio link.

Therein, the invention allows using an existing energy and/or communication interface of a light installation or the lighting device or also an illuminant of the lighting device for the energy supply of one or more of the transmitting devices or beacons due to the arrangement of the transmitting device or the beacon. This can for example also include communication interfaces of an electronic ballast (ECG) of the lighting device as well as communication and/or combined energy and communication interfaces on the secondary side and/or primary side.

A possibility, in which a separate energy converter for the transmitting device or the beacon can be saved, is further an electrical connection of the transmitting device or the beacon in parallel with an illuminant, in particular with a light emitting diode unit or a group of light emitting diodes or possibly a light emitting diode carrier module and/or the like.

The invention provides that the at least one controllable device is assigned to the transmitting device or the beacon. Thereby, a connection between the controllable device and the transmitting device or the beacon is established such that selectivity with respect to the control of the controllable device can be achieved. Thus, it is no longer possible to be able to nearly arbitrarily control the controllable device with communications terminals. Hereby, the basis is rather provided that the controllable device can only be controlled on preset conditions.

Hereto, the invention proposes that the communications terminal receives the radio signal of the transmitting device or the beacon and ascertains the specific identification data of the transmitting device or the beacon from it. Based on the ascertained specific identification data, it is now possible to ascertain the controllable devices assigned to the transmitting device. Thereby, any controllable devices are no longer available on the communications terminal side, but only those, which result as located in the preset region due to the communication range with the beacon. Thereby, selectivity is provided, which allows being able to control controllable devices only by authorized or authenticated communications terminals.

Preferably, it is provided that only if the controllable device has been ascertained as assigned to the transmitting device, a communication link between the at least one device and the communications terminal is established and data corresponding to a control command for controlling the at least one device is communicated.

Thereby, safety-critical infrastructure devices as the controllable devices can at least partially be protected from unauthorized access. The access can be restricted to only controllable devices arranged in close vicinity by means of the invention.

Of course, it can fundamentally also be achieved by the invention, that especially if the communication range to a beacon is established, a corresponding assigned controllable device can precisely not be controlled. Controllability can only be provided if the communication link to the transmitting device or the beacon does no longer exist or the radio signal can no longer be received by the communications terminal. This is for example advantageous for safety-relevant regions, in which works are performed by personnel, and controllable devices can entail dangerous states for the personnel. Thereby, it can be avoided that a controllable device is inadvertently operated by a user located in communication range to the beacon, which could entail a dangerous state for the user.

The invention can be particularly advantageously employed in office buildings, which for example comprise multiple rooms, in particular conference rooms and offices, which can be equipped with electrically controllable air conditioners, lighting devices, shutters and/or the like as the controllable devices. Therein, the control of the respective controllable devices can be performed via an implementation or application on the communications terminal by a user of the communications terminal. For example, it can be provided that depending on in which room of the office building the user is located, the controllable devices can be manually selected from a list. Hereby, increased effort can arise because the controllable devices first have to be identified. Furthermore, a controllable device in another room can be controlled by erroneous use, wherefrom disturbance of for example other persons in this room can arise or also increased energy consumption can be the consequence, for example if a heating device as the controllable device or also a controllable air conditioner is controlled.

The deactivation of the control possibility can for example prove advantageous for the use of means of public transport by the invention in that for example a user purchases an electronic ticket by means of his communications terminal. Since the ticket usually has to be bought before travel commencement, it can be achieved by the invention that the purchase function is no longer possible during the use of the means of public transport, that is it is blocked. This can be achieved in that corresponding transmitting devices or beacons are arranged in the means of transport, and as soon as the communications terminal of the user is in communication range to the beacon, the purchase function of the communications terminal, which can for example be realized by means of an implementation or application, is deactivated.

Within the scope of the invention, enabling and deactivation, respectively, of the control possibility of a controllable device is provided based on received radio signals of the transmitting device or the beacon, wherein the control of the controllable device is effected by means of the communications terminal and preferably additionally includes a database with corresponding system information, in particular with respect to the overall system and an assignment of the controllable devices to transmitting devices or beacons. Therein, the database can for example be of the communications terminal, be provided as a separate service server, be formed as part of the transmitting device or also as a Cloud application.

In the last mentioned case, access by the communications terminal via a wireless communication channel can be provided.

By means of the system proposed by the invention, enabling of controllable devices like infrastructure elements and the like can be achieved for instance depending on a specific site within the building or office building or the preset region, which can subsequently be controlled by the user by means of the communications terminal. Similarly, deactivation of a service can be effected depending on the site, which is not to be possible in the respective position or in the respective preset region.

Therein, the transmitting device or the beacon, which is arranged in or immediately at the lighting device and is preferably supplied with electrical energy by the lighting device, constitutes a basis of the invention. Thereby, the reliability required for the control possibilities provided according to the invention in the intended operation can be achieved. Even if the transmitting device or the beacon can be arranged separated or distant from the lighting device, it can preferably be arranged in or immediately at the lighting device. Thereby, the position of the transmitting device can be immediately assigned to the position of the lighting device.

It can be provided that an electrical connection of the transmitting device or the beacon in parallel with light emitting diode modules or with a group of light emitting diodes or possibly with a light emitting diode carrier module is provided such that an expensive energy converter is not required if possible. Thereby, the reliable energy supply required for the intended operation can be realized.

Moreover, there is the possibility of using existing energy and communication interfaces of a digitally controlled light installation for the energy supply of the transmitting device or the beacon. This can include on the interface primary side from the electronic ballast as well as communication and/or combined energy and communication interfaces. Since the primary interface is usually applied with electrical voltage in digitally controlled light installations, energy supply for the transmitting device or the beacon can be ensured even if for example the lighting device is deactivated or switched off.

The radio signal of the transmitting device or the beacon contains the specific identification data, which is preferably cyclically emitted by means of the radio signal. The specific identification data includes a unique identifier, namely the UUID, which can be emitted by means of a data transfer protocol such as for example iBeacon® of the company Apple Inc., Eddistone® of the company Google or the like. The specific identification data is received and evaluated by the communications terminal, for example in that the specific identification data is matched in a database, for example to ascertain available controllable devices in the preset region, for example a room or the like, or positions of the transmitting device or the beacon and the assigned controllable devices recorded by means of a layout plan. Further uses can be realized based thereon.

The communication link between the communications terminal and the controllable device can for example be effected in wired and/or wireless manner. Therein, the communication link can use a preset communication protocol. The communication link is preferably bidirectional such that data for the control command cannot only be communicated to the controllable device, but data can also be received by the controllable device, for example with respect to a preset operating state and/or the like. However, an unidirectional communication link is fundamentally sufficient for controlling the controllable device, which allows communicating the data corresponding to the control command to the controllable device.

The assignment of the at least one controllable device to the transmitting device can for example be effected in that a file is present in a database, in which the transmitting device is assigned to a respective controllable device or vice versa, for example in the manner of a table or the like. However, the assignment can also be effected in that the controllable device receives the radio signal of the transmitting device and communicates a corresponding assignment signal to the transmitting device or also to a center or the like, where the corresponding assignment is then retrievably kept available.

The evaluation of the radio signal serves for capturing the specific identification data. The evaluation of the radio signal can be performed by the communications terminal itself or also by a device, which is arranged distant from the communications terminal and with which the communications terminal is in communication link, for example via a mobile radio network, an Internet access, for example by means of WLAN or the like. If the evaluation of the radio signal is externally effected with respect to the communications terminal, the specific identification data can be communicated to the communications terminal by the device performing the evaluation.

Ascertaining the at least one controllable device assigned to the transmitting device is effected based on the captured specific identification data. This step too can be performed by the communications terminal itself. However, it can alternatively also be provided that the device, which has already performed the evaluation of the radio signal, performs ascertaining and for example communicates a list with controllable devices assigned to the respective transmitting order to the communications terminal as a result of ascertaining. Preferably, only these ascertained controllable devices are presently controllable by means of the communications terminal. Thereby, it is not only allowed a clear representation with respect to the selection of the devices to the user, which he would like to control, but it moreover allows that controllable devices, which are not assigned to the transmitting device, cannot be controlled by the communications terminal. Inversion can fundamentally also be provided to the effect that precisely the devices are not to be controlled, which are assigned to the transmitting device. This configuration is for example suitable for the above already described ticket obtaining problem.

Establishing the communication link between the at least one device and the communications terminal can for example be effected in automated manner, for example in that the controllable devices have previously been ascertained. However, it can also be provided that the user himself performs an input at the communications terminal, whereupon only then the communication link is established. This is for example advantageous if more than one single controllable device has been ascertained, which is assigned to the transmitting device, in particular if it is within the scope of the usual use to control only a single one of these devices.

It proves particularly advantageous if ascertaining includes providing enabling data, which allows the controllable device executing the control command of the communications terminal, and/or allows the communications terminal outputting the control command to the controllable device. Thereby, further selectivity can be achieved such that not any communications terminal is able to control the controllable device, which is in communication range to the transmitting device or to the beacon. Preferably, the enabling data can be digital data, which is provided in ascertaining the at least one controllable device assigned to the transmitting device based on the captured specific identification data. The enabling data can also be given by a preset encoding, in particular by an encryption and/or the like.

Preferably, ascertaining the enabling data includes that position data for a position of the communications terminal is ascertained at least using the specific identification data of the transmitting device and it is ascertained based on the ascertained position data if the control appliance is positioned in the preset region. Thereby, spatial localization can be achieved, which has as the result if the communications terminal is located in the preset region. If the communication range is positioned in the preset region, a corresponding enabling datum or also corresponding enabling data can be provided. Herein, however, the enabling data can fundamentally also consist in the position data itself or at least include it. In contrast, if the communications terminal is positioned outside of the preset region, this can also be ascertained based on the enabling data in that the enabling data contains corresponding data preventing controllability of the controllable device.

Moreover, it is proposed that ascertaining includes installing a specific computer program for a computer unit of the communications terminal. Thus, for ascertaining the at least one controllable device assigned to the transmitting device, it is possible to obtain a corresponding computer program from a database, to install it on the communications terminal and to control the controllable device by means of this computer program if a corresponding authorization, in particular enabling data, is present. Moreover, the computer program can be used to ascertain the enabling data. Further, the computer program can be used to provide a corresponding user guidance such that the user can select the possible controllable devices for controlling. Finally, there is the possibility of establishing a specific communication link with the respective controllable device by means of the computer program, for example an encrypted communication channel or the like, to be able to achieve a reliable, secure control of the controllable device. The specific computer program can be requested from the database by means of the communications terminal based on the specific identification data. The communications terminal is preferably in communication link with the database such that it can communication a corresponding request command to the database.

According to a development, it is proposed that ascertaining includes matching with a database, which contains data at least with respect to the lighting device, the at least one controllable device and the preset region. Thereby, corresponding assignments can be retrievably provided in simple manner. The database can be arranged in an external device, but also at least partially in the communications terminal itself.

Further, it is proposed that establishing the communication link includes that the communication link is established at least via a control center. Herein, an immediate communication link between the communications terminal and the controllable device thus does not have to be established. Instead, the controllable device can be connected to the control center via a communication link and be correspondingly controlled by it. The control center is then indirectly in communication link with the communications terminal via the communication link such that the communications terminal communicates the data for the control command to the control center. The control center can then forward this data to the controllable device in preset manner or optionally also previously convert it into a suitable data format before forwarding to the controllable device is effected. This configuration has the advantage that other wireless communication links can also be used for establishing the communication link, such as for example a communication link via at least partially a mobile radio network or the like. Here too, the communication link can be unidirectionally or bidirectionally formed according to need.

Furthermore, it can be provided that establishing the communication link includes establishing a communication link with the control center, wherein the at least one device is controlled via the control center. Thus, in this configuration, the control command is not simply passed to the controllable device by the control center, but the controllable device is controlled by means of the control center, wherein a control command is communicated from the communications terminal to the control center, the control center optionally converts it and then correspondingly performs or causes control of the controllable device. Moreover, additional functions can be additionally realized by the control center, for example with respect to safety, consistency of the control command with the respective current operating state of the controllable device and/or the like.

Furthermore, it is proposed that the position data is matched with the preset region for the purpose of authentication of the position of the communications terminal, and the data for controlling is only communicated to the at least one device and/or the device only executes the control command corresponding to the data for controlling if the position of the communications terminal is authenticated. This configuration can further improve the reliability with respect to the selectivity of the control of the controllable device because improved safety can be achieved by the authentication. For authenticating, further radio signals of other transmitting devices as well as optionally also further localization functions of the communications terminal can for example be brought in besides the radio signal of the transmitting device.

Advantageously, it is proposed that the enabling data includes authorization information, wherein the authorization information is specific to an individual preset communications terminal or to a preset group of communications terminals.

Thereby, it can be achieved that only preset ones of the communications terminals are able to control the controllable device. For this purpose, it can be provided that the communications terminal itself communicates an identification, for example a SIMM number or the like, which is for example examined by the control center or also by the controllable device itself. With positive examination, a corresponding control possibility can be enabled. The authorization information can also be provided in the form of digital data.

According to a development, it is proposed that the transmitting device is at least partially supplied with energy via the lighting device for its intended operation, preferably independently of an intended operation of the lighting device. This configuration has the advantage that a substantially continuous, preferably uninterrupted, energy supply can be provided for the transmitting device or the beacon. Especially for the use according to the invention, this is of particular advantage because it can be provided according to configuration of the system that the controllable device can be exclusively controlled by means of the communications terminal. However, since the controllability of the controllable device depends on the function of the transmitting device or the beacon, disturbance at the transmitting device or the beacon would also entail disturbance with respect to the controllability of the controllable device. In order to improve the availability of the service provided by the invention here, the energy supply via the lighting device is provided. Therein, it is preferably taken into account that the lighting device usually comprises an energy supply connection, which preferably permanently provides energy for the intended operation. This can also be a communications connection of a communication network, to which the lighting device is connected.

Further, it is proposed that a setting profile associated with the communications terminal is used for controlling the at least one device. The user can create a profile on the communications terminal, which contains preset settings, which are communicated to the controllable device. It can be provided that the setting profile is communicated to the controllable device as a whole and the controllable device performs the settings corresponding to the setting profile in automated manner.

However, it can moreover also be provided that the communications terminal communicates a corresponding control command to the controllable device based on the setting profile in automated manner. The association of the setting profile and the communications terminal can for example be effected by means of identification data of the communications terminal, for example a SIMM number or the like. The setting profile itself can for example be provided in the form of a file including digital data.

Moreover, it can be provided that controlling the at least one device is at least partially effected in automated manner based on at least one suitable parameter, which can for example be captured by means of suitable sensors. Thereby, intervention by means of the communications terminal and/or a user does not have to be provided to execute the control. A parameter can for example be a presence of a person, his vital parameters, a time of day and/or the like.

Furthermore, it can be provided that if the communications terminal receives the radio signal, updates for computer programs (software, firmware) are proposed, for example for the transmitting device or the beacon, for the controllable device and/or the like. Thereto, the communications terminal can for example establish a communication link from the transmitting device or the beacon and/or the controllable device with one or more suitable databases such that a possible update can for example be performed in automated manner. The communication link can be established via a mobile radio network, a gateway or the like. For this purpose, it can also be provided that the communications terminal contacts suitable databases via a global communication network like the Internet or the like after reception of the radio signal to obtain corresponding data. This too, can be effected in automated manner. It proves particularly advantageous if the update is performed in automated manner as soon as the communications terminal gets into communication range to the transmitting device.

Moreover, it is proposed that the control of the at least one controllable device is effected in automated manner according to the setting profile as soon as the communications terminal receives the radio signal. This configuration has the advantage that the user of the communications terminal himself does not have to take actions in order that the controllable device performs the desired setting.

Furthermore, it is proposed that the control of the at least one device includes taking an initial setting in automated manner if the communications terminal is outside of a reception range with respect to the communication signal. This has the advantage that the controllable device takes the initial setting in automated manner as soon as the communications terminal is outside of the reception range with respect to the transmitting device and does no longer receive the radio signal. The initial setting can for example be a setting, in which the controllable device takes a protected or energetically beneficial operating state, for example with a shutter, retracting the shutter in order to protect it from weather impacts or the like.

The implementation variants as well as advantages and effects specified with respect to the method according to the invention analogously similarly apply to the illumination device according to the invention as well as vice versa. Therein, respective method features can be regarded as functional features for means suitable hereto.

Further advantages and features are apparent by the embodiments specified in the following based on the attached figures. In the figures, identical reference characters denote identical features and functions.

There show:

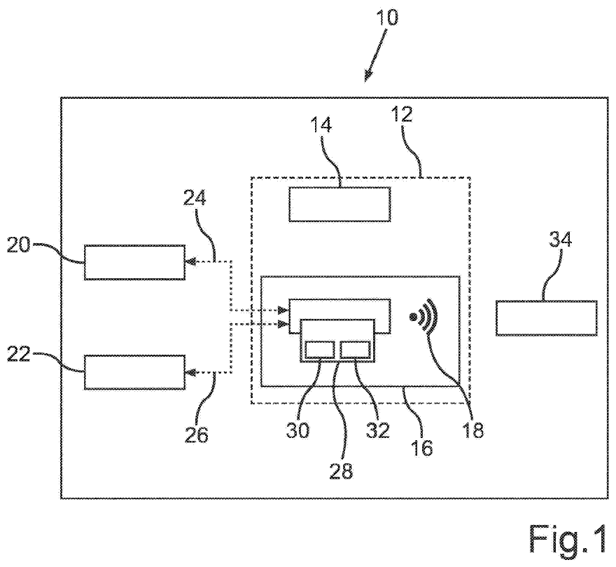

FIG. 1 in a schematic block diagram an integration of a beacon as a transmitting device in a lighting device of an illumination system comprising multiple lighting devices,

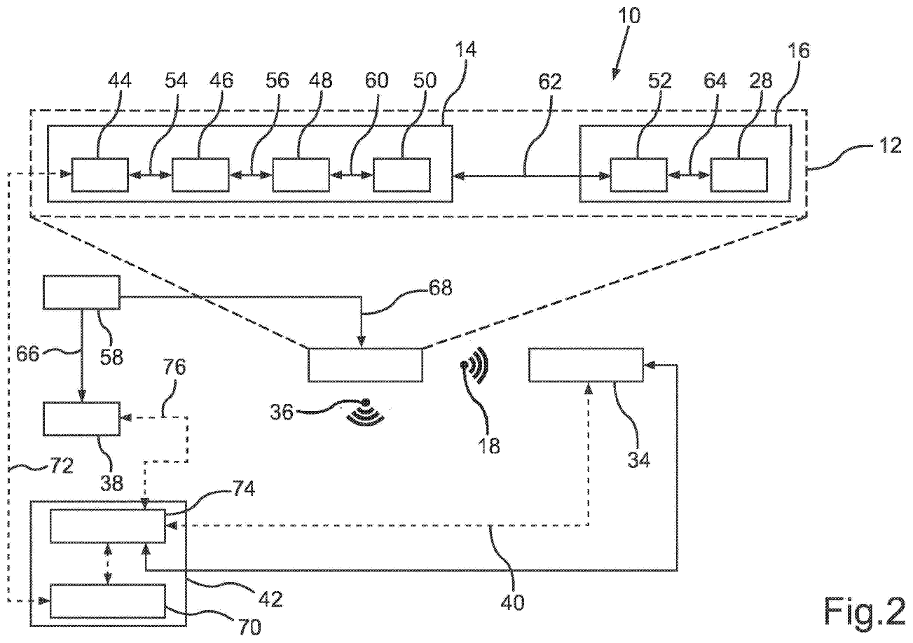

FIG. 2 a schematic block diagram for a first configuration of a system according to the invention,

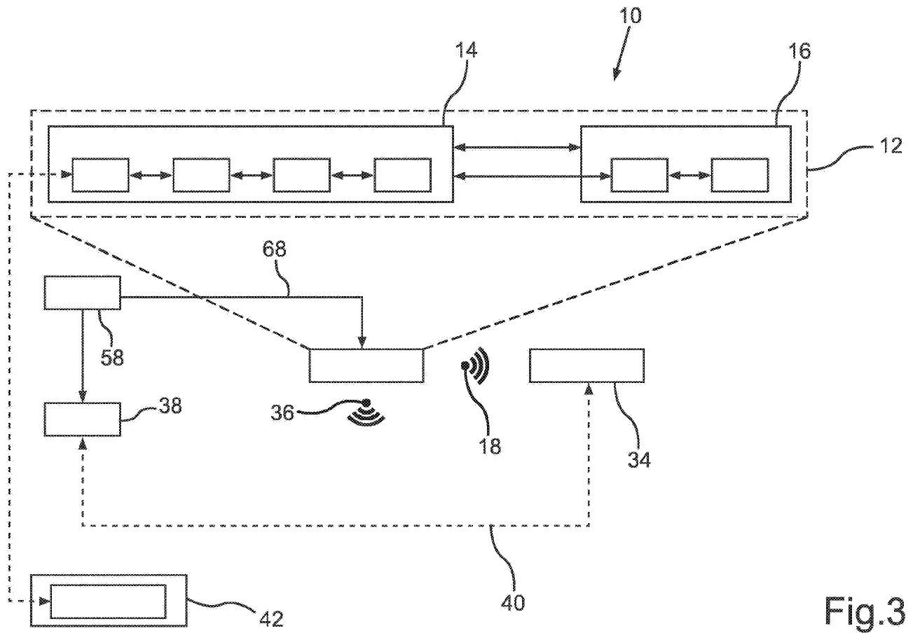

FIG. 3 a schematic block diagram for a second configuration of a system according to the invention, and

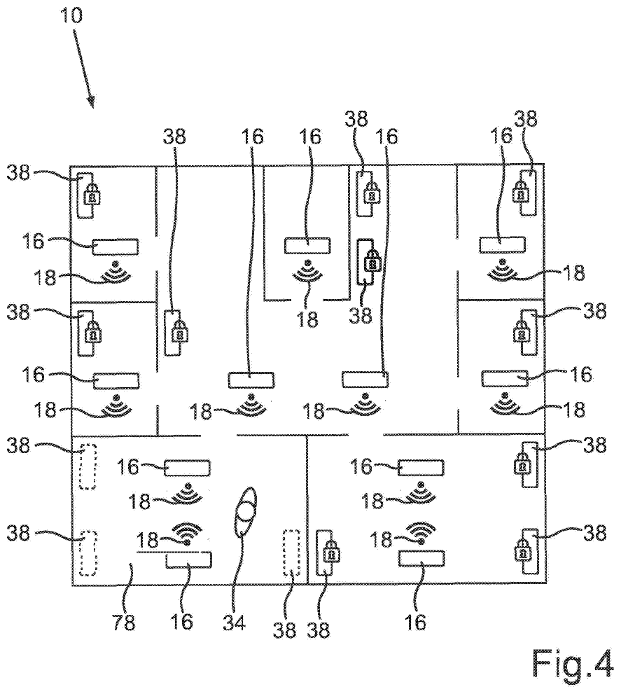

FIG. 4 a schematic representation of a floor of an office building comprising a system according to the invention.

FIG. 1 shows an illumination system 10 as a system in a schematic block diagram, which includes a lighting device 12 as well as a plurality of further lighting devices 20. Each of the lighting devices 12, 20 comprises an illuminant 14 for emitting light as well as a beacon 16 as a transmitting device. The beacon 16 is presently arranged in the lighting device 12. The beacon 16 wirelessly unidirectionally emits a radio signal 18 with identification data specific to the beacon 16 in the manner of broadcast. The emission is presently effected using near-field radio based on a Bluetooth Low Energy (BLE) protocol.

The beacon 16 includes a control unit 28, which includes a computer unit 30 as well as a storage unit 32 communicatively coupled to the computer unit 30. An executable computer program for the computer unit 30 is stored in the storage unit 32 such that a preset functionality can be provided by the computer unit 30. Presently, the functionality serves for operating the beacon 16 in presettable manner. The further lighting devices 20 are fundamentally constructed comparable to the lighting device 12.

Presently, the beacon 16 is formed as a transmitting-receiving device, which also can provide a bidirectional communication link 24 besides the emission of the radio signal 18. The lighting device 12, and here in particular the beacon 16, is connected to the further lighting devices 20 or the beacons thereof, which are correspondingly formed, via the communication link 24.

The communication link 24 is presently a bidirectional communication link, which is also based on near-field radio and uses the above mentioned BLE standard.

Moreover, the lighting device 12 and here also again in particular the beacon 16 is in communication link with an infrastructure device 22 via a further communication link 26, via which data relating to an intended operation of the lighting device 12 as well as also data with respect to the further lighting devices 20 can be exchanged. Accordingly, the lighting device 12 and here in particular the beacon 16 thereof also serve as a device for forwarding corresponding data from the infrastructure device 22 to the lighting devices 20 and vice versa at the same time, for example in the manner of a network node.

The radio signal 18 respectively emitted by the beacon 16 or the beacons of the lighting devices 20 can be received and evaluated by one or also multiple communications terminals 34. The communications terminal 34 is presently a mobile radio terminal in the manner of a smartphone. In the present configuration, it is provided that only the communications terminals 34 receive and evaluate the radio signal 18. Therefore, communication is only unidirectionally effected. Non-illustrated beacons of the further lighting devices 20 can also be received by the communications terminal 34 if they are in communication range to the communications terminal 34. Thereby, a series of services can be provided or allowed by means of the communications terminal 34, which allow a user of the communications terminal 34 to use very different additional services.

Within a preset region, in which the lighting devices 12, 20 are arranged and in which the radio signal 18 can be received by the communications terminal 34, the user of the communications terminal 34 can thereby better orient himself and navigate, respectively, as well as also locate and use other local, in particular digital, services, such as for example apps, app functions, Google Maps, Lightify, light control and/or the like. The illumination system 10 with the beacons 16 arranged in the respective lighting devices 12, 20 allows a localization and orienting system, respectively, for the above mentioned user potentials. In particular, it is possible to provide an accurate self-localization of the communications terminal 34, whereby services become usable, such as for instance the navigation or the provision of location-specific information.

An aspect of the beacon technology is the possibility of configuration of typical parameters such as for example a signal strength and/or a transmission interval of the radio signal 18 of the beacon 16. With different configurations, different application scenarios can be individually supported. For example, if high service quality, for example accurate localization in short intervals, is desired, as it is in particular required in indoor navigation, very short transmission intervals can preferably be configured.

FIG. 2 shows an illumination system 10 according to the invention in a schematic block diagram, which is presently arranged in an office building not illustrated in more detail. In FIG. 2, the illumination system 10 is arranged in a room of the office building. The illumination system 10 includes a controllable device, which is presently formed by an electrically drivable shutter 38 as a technical infrastructure element. The illumination system 10 further includes a transmitting device presently arranged in a lighting device 12, which is formed by a beacon 16. The beacon 16 wirelessly emits a radio signal 18 with identification data specific to the beacon 16 in the manner of near-field radio into the room as the preset region. The shutter 38 is assigned to the beacon 18. The radio signal 18 is fundamentally formed as the radio signal 18 according to FIG. 1.

Presently, the lighting device 12 includes the illuminant 14, which is illustrated together with the beacon 16 in an enlarged representation in detail in FIG. 2 in the upper area. Accordingly, the illuminant 14 includes a unit 44 for information processing and light control, which is connected to an electronic ballast 46 via an energy transfer channel 54. The electronic ballast 46 is further connected to an energy interface 48 via an energy transfer channel 56, which in turn is connected to a light emitting diode module 50 via an energy transfer channel 60. Light 36 is emitted by the lighting device 12 by means of the light emitting diode module 50 in preset manner.

As already explained to FIG. 1—the beacon 16 comprises the control unit 28, which presently includes a non-illustrated radio unit, by means of which the radio signal 18 is emitted in preset manner. The control unit 28 is connected to an energy interface 52 of the beacon 16 via an energy transfer channel 64 together with the radio unit. The energy interface 52 in turn is immediately connected to the illuminant 14 via an energy transfer channel 62 and is supplied with electrical energy for the intended operation of the beacon 16 by it. Presently, it is provided that an uninterrupted energy supply is provided for the beacon 16 via the lighting device 12.

The illuminant 14 as well as also the beacon 16 is arranged in a common housing (not illustrated) of the lighting device 12. For the purpose of the energy supply of the lighting device 12, it is connected to a mains supply 58 via an energy transfer channel 68, which is provided by a public energy supply network. The mains supply 58 also supplies the shutter 38 with electrical energy for its intended operation via an energy supply channel 66.

Presently, it is provided that the operation of the beacon 16 is independent of an operating state of the illuminant 14 and the beacon 16 is in particular also supplied with electrical energy via the lighting device 12 if the illuminant 14 is deactivated and light 36 is not emitted. Thereby, the intended operation of the beacon 16 can be realized independently of the operation of the illuminant 14.

In the present configuration, it is provided that the building includes a building management device 42, which includes a light management unit 70. The light management unit 70 is connected to the unit 44 for information processing and light control of the illuminant 14 via a communication interface 72 and hereby controls the light emission of the illuminant 14.

Among other things, the building management device 42 constitutes a control center and further includes a central data processing 74, which is in communication link with the light management unit 70. Moreover, a communication link 76 exists between the central data processing 74 and the shutter 38, via which control commands for the intended operation of the shutter 38 can be communicated. Moreover, operating states of the shutter 38 can be communicated to the central data processing 74.

The illumination system 10 further includes a communications terminal 34 for controlling the shutter 38, wherein the communications terminal 34 is formed to receive and evaluate the radio signal 18 to capture the specific identification data. Presently, the communications terminal 34 is constituted by a smartphone. The communications terminal 34 is presently further in communication with the central data processing 74 via a communication link 40.

The illumination system 10 further includes the central data processing 74 as an ascertaining unit for ascertaining the shutter 38 as the controllable device assigned to the beacon 16 based on the captured specific identification data, which has been extracted from the radio signal 18. For this purpose, the communications terminal 34 communicates the received radio signal via the communication link 40 to the central data processing 74, which ascertains the shutter 38 as the controllable device assigned to the beacon 16 and communicates corresponding data via the communication link 40 back to the communications terminal 34.

In an alternative configuration, it can also be provided at this place that the communications terminal 34 itself includes the ascertaining unit and ascertains the shutter 38 as the controllable device assigned to the beacon 16 by query to the central data processing 74 via the communication link 40.

For the purpose of ascertaining the shutter 38 as the controllable device assigned to the beacon 16, thus, centralized map data on a server can be matched and a unique position of the communications terminal 34 can be ascertained.

For controlling the shutter 38, data corresponding to a control command is now communicated to the shutter 38 via the communication link 40 as well as the communication link 76, which then carries out a corresponding control function. If the ascertaining unit is encompassed by the communications terminal 34, establishing the communication link 40 with the shutter 38 can also first be provided hereto. The communication link 40 is preferably also a wireless communication link, in particular a radio link, which can for example be formed via a mobile radio network or also a near-field radio communication network, for example based on WLAN or the like.

In this configuration, ascertaining the shutter 38 as the controllable device assigned to the beacon 16 includes providing enabling data, which allows the communications terminal 34 to pass the control command to the shutter 38. For this purpose, it is presently further provided that the enabling data includes position data for a position of the communications terminal 34 using the specific identification data of the beacon 16, wherein it is ascertained based on the ascertained position data if the communications terminal 34 is positioned in the preset region. Only if the communications terminal is positioned in the preset region, the communications terminal 34 can communicate the data corresponding to the control command to the shutter 38. For this purpose, it is further provided that an application or app is installed on the communications terminal 34, which includes a specific computer program for a computer unit of the communications terminal 34. By means of the application, it can be achieved that the data corresponding to the control command is only communicated to the shutter 38 if the communications terminal 34 is positioned in the preset region. This is presently determined by a communication range, which is determined in that the communications terminal 34 receives the radio signal 18.

Even if it is presently provided that the data for the control command is immediately forwarded to the shutter 38 by the central data processing, thus, the central data processing 74 presently functions as a network node, it can also be provided in an alternative configuration that the central data processing 74 performs corresponding conversion and converts the data received from the communications terminal 34, optionally even subjects it to further examination, and communicates specific control data to the shutter 38.

Thus, position determination of the communications terminal 34 within the building is effected preferably based on digital layout plans, in which positions of the individual beacons 16 are recorded with the corresponding specific identification data within a service area. If the communications terminal 34 receives one or more radio signals 18, the accurate position thereof in the building can now be ascertained. Therein, the position accuracy can depend on various factors like a number of received radio signals, evaluation algorithms and the like. Depending on the ascertained position of the communications terminal 34 in the service area, for example the preset region, which is here constituted by a room of the building, the controllable technical devices, here the shutter 38, in the environment can be displayed on the communications terminal 34. Access to the controllable devices is presently effected via the communications terminal 34, on which the corresponding application or app for the device to be operated, here the shutter 38, is installed.

FIG. 4 shows a floor of the building in a schematic representation, in which the illumination system 10 is arranged. It is apparent that a plurality of rooms are provided, in which beacons 16 are arranged, which each emit specific identification data by means of respective radio signals 18. Moreover, controllable devices 38 are arranged in the respective rooms, which can be controlled by the above described method. The building management device 42 is not illustrated in FIG. 4.

The beacons 16 are presently arranged in respective lighting devices 12 (not illustrated), as it has already been explained based on FIGS. 1 and 2. In one of the rooms, namely the room 78, a user with his communications terminal 34, the smartphone, is positioned. The communications terminal 34 receives two radio signals 18 from two beacons 16 arranged in the room 78. Thereby, an accurate position of the communications terminal 34 can now be ascertained. Presently, the communications terminal 34 is located in the room 78 as the preset region. Further, controllable devices 38 not further specified are arranged in the room 78, which can for example represent a shutter. However, the controllable device 38 can moreover also be a heating or air conditioning device. According to the invention, the controllable devices 38 of the room 78 are controllable by means of the communications terminal 34. In particular, the controllable devices 38 of the room 78 are assigned to the beacons 16 of the room 78. Presently, room-wise assignment is preferably provided.

In an adjacent one of the rooms, namely the room 80, further controllable devices 38 are arranged, but which are assigned to other beacons 16, namely the beacons 16, which are also arranged in the room 80. By means of the method according to the invention, this is recognized such that the controllable devices 38 of the room 80 cannot be controlled by the communications terminal 34, which is located in the room 78. This is prevented by the invention, as already previously explained with respect to FIG. 2. In FIG. 4, the controllable devices 38, which are not controllable in the currently illustrated position of the communications terminal 34 in the room 78, are identified with a lock symbol. Presently, they are the controllable devices 38 outside of the room 78.

Thus, it is provided that the communications terminal 34 determines its own position within the building from the specific identification data. Presently, the own position is within the room 78. For determining the position, a layout plan of the lighting devices 12 is used, which contain the beacons 16, which include respective specific identification data. From a matching of the received radio signal 18 as well as a field strength measurement of the radio signals 18, an accurate position can be ascertained in this manner.

Preferably, the communications terminal 34 communicates with the central data processing 74, wherein both a wired and a wireless communication link as well as combinations hereof are possible. The central data processing 74 authenticates a site of the communications terminal 34 and thereupon forwards the control commands and the corresponding data, respectively, to the corresponding controllable devices like the shutter 38. Herein, depending on the controllable devices like the shutter 38, wired as well as also wireless communication links as well as combinations hereof can be used as the communication channels.

FIG. 3 shows a further configuration for an illumination system 10 according to the invention, wherein this configuration is based on the above described configuration already explained according to FIG. 2 for an illumination system 10 according to the invention, wherefore reference is additionally made to the explanations in this respect.

In contrast to the configuration according to FIG. 2, it is provided in the configuration according to FIG. 3 that the communications terminal 34 establishes a communications link 40 immediately with the shutter 38. Thus, a central data processing is here no longer interposed. Preferably, here too, the communication link 40 is wirelessly formed. However, according to type of the communications terminal 34, it can also be wired or also be formed by a combination hereof.

In this configuration, the communications terminal 34 can determine the own position within the preset region from the specific identification data of the beacon 16. For determining the own position, a layout plan of the lighting device 12 and the beacons 16 arranged therein, respectively, is presently again used, in which the respective specific identification data of the beacons 16 of the lighting devices 12, 20 are recorded. From matching the radio signal as well as a field strength measurement, the position and thereby position data can be ascertained in this manner. The communications terminal 34 thus directly communicates with the controllable device, presently the shutter 38. Herein, authentication of the site of the communications terminal 34 is effected by the communications terminal 34 itself.

The embodiments only serve for explaining the invention and are not intended to restrict it.

### LIST OF REFERENCE CHARACTERS

10 Illumination system
12 illumination device
14 lighting device
16 beacon
18 radio signal
20 illumination device
22 infrastructure device
24 communication link
26 communication link
28 control unit
30 computer unit
32 storage unit
34 communications terminal
36 light
38 controllable device
40 communication link
42 building management device
44 light control
46 ballast
48 energy interface
50 light emitting diode module
52 energy interface
54 energy transfer channel
56 energy transfer channel
58 mains supply
60 illumination device
62 energy transfer channel
64 energy transfer channel
66 energy supply channel
68 energy transfer channel
70 light management unit
72 communication interface
74 central data processing
76 communication link
78 room
80 room

1. A method for controlling at least one controllable device arranged in a preset region by operation of a communications terminal, wherein a transmitting device wirelessly emits a radio signal with identification data specific to the transmitting device, comprising the steps of the method comprising:
assigning the at least one controllable device to the transmitting device,
receiving the radio signal by mens of operation of the communications terminal,
evaluating the radio signal for capturing the specific identification data,
ascertaining the at least one controllable device assigned to the transmitting device based on the captured specific identification data,
establishing a communication link between the at least one device and the communications terminal, and
communicating data corresponding to a control command for controlling the at least one device and/or the transmitting device itself.

2. The method according to claim 1,
wherein
ascertaining includes providing enabling data, which allows the controllable device to execute the control command of the communications terminal, and/or allows the communications terminal to pass the control command to the controllable device.

3. The method according to claim 2,
wherein
ascertaining the enabling data includes that position data for a position of the communications terminal is ascertained at least using the specific identification data of the transmitting device and it is ascertained if the communications terminal is positioned in the preset region based on the ascertained position data.

4. The method according to claim 1,
wherein
ascertaining includes installing a specific computer program for a computer unit of the communications terminal.

5. The method according to claim 1,
wherein
ascertaining includes matching with a database, which contains data at least with respect to a lighting device, the at least one controllable device and the preset region.

6. The method according to claim 1,
wherein
establishing the communication link includes that the communication link is established at least via a control center.

7. The method according to claim 6,
wherein
establishing the communication link includes establishing a communication link with the control center, wherein the at least one controllable device is controlled via the control center.

8. The method according to claim 1,
wherein
for the purpose of authentication of the position of the communications terminal, the position data is matched with the preset region and the data for controlling is only communicated to the at least one controllable device and/or the controllable device
only executes the control command corresponding to the data for controlling if the position of the communications terminal is authenticated.

9. The method according to claim 2,
wherein
the enabling data includes authorization information, wherein the authorization information is specific to an individual preset communications terminal or to a preset group of communications terminals.

10. The method according to claim 1,
wherein
the transmitting device is at least partially supplied with electrical energy for its intended operation via a lighting device.

11. The method according to claim 1,
wherein
a setting profile associated with the communications terminal is used for controlling the at least one controllable device.

12. The method according to claim 11,
wherein
controlling the at least one controllable device is effected in automated manner according to the setting profile as soon as the communications terminal receives the radio signal.

13. The method according to claim 11,
wherein
controlling the at least one controllable device includes taking an initial setting in automated manner if the communications terminal is outside of a reception range with respect to the radio signal.

14. The method according to claim 1,
wherein
the at least one controllable device establishes a communication link with the transmitting device in automated manner, whereby the controllable device is assigned to the transmitting device.

15. The method according to claim 1,
wherein
controlling also includes controlling the transmitting device.

16. The method according to any one of the preceding claims claim 1,
wherein
controlling the at least one device is effected at least partially in an automated manner based on at least one suitable parameter.

17. The method according to claim 1,
wherein
when the communications terminal receives the radio signal, updates for computer programs are proposed.

18. The method according to claim 17,
wherein
the updates are carried out in an automated manner as soon as the communications terminal gets into communication range to the transmitting device.

19. A system for controlling at least one controllable device arranged in a preset region, comprising:
the controllable device,
a transmitting device wirelessly emitting a radio signal with identification data specific to the transmitting device, wherein the at least one controllable device is assigned to the transmitting device,
a communications terminal for controlling the controllable device and/or the transmitting device, wherein the communications terminal is formed to receive the radio signal and to evaluate it for capturing the specific identification data,
an ascertaining unit for ascertaining the at least one controllable device assigned to the transmitting device based on the captured specific identification data,
wherein a communication link can be established between the at least one device and the communications terminal to communicate data corresponding to a control command for controlling the at least one controllable device.

20. The system according to claim 19,
wherein
the transmitting device is arranged in or immediately at a lighting device.
